(19) United States
(12) Patent Application Publication
(10) Pub. No.: US 2003/0196537 A1
(43) Pub. Date: Oct. 23, 2003

(54) Guitar

(76) Inventor: Mark Leuchter, Bal Harbour, FL (US)

Correspondence Address: Bill Goldman, 1755 Embarcadero Road, Palo Alto, CA, 94303, US

(21) Appl. No.: 10/126,922

(22) Filed: Apr. 19, 2002

(51) Int. Cl. G10D 3/00

(52) U.S. Cl. 84/291

(57) ABSTRACT

A music instrument capable of emulating particular tones comprises an instrument body, a neck portion having a neck tenon that extends a predetermined distance into the instrument body to form a neck-to-body joint, a neck position pickup mounted above the neck tenon such that the sound captured by the neck position pickup resonates in concert with the neck portion, and a bridge position pickup mounted upon the instrument body such that the sound captured by the bridge position pickup resonates in concert with the instrument body. The neck position pickup and the bridge position pickup emulate respective vintage tones.

The present invention relates generally to guitars, and more specifically, to a unique guitar structure capable of emulating vintage tones.

### BACKGROUND OF THE INVENTION

Electric guitars all function on the same fundamental principles which stem from conventional design standards. A neck is traditionally bolted on or glued into a body (known respectively as “bolt-on” or “set” necks). This is shown in FIGS. 1A and 1B, respectively.

In FIG. 1A, which illustrates a conventional “bolt on” neck construction, the neck is held in place by screws (usually three to four screws) in a rebate on the guitar body. The advantage of this type of construction is that it makes maintenance and replacement very easy if Q the neck breaks, warps or needs leveling, as the neck is easily removable. The disadvantage is that some of the sustain is lost through the neck joint.

In FIG. 1B, which illustrates a conventional glued-in neck construction, the neck is glued into place, using a tenon joint to the guitar body. The advantage of a glued in neck is that there is very little loss of sustain.

Further describing conventional electronic guitar construction, a tailpiece, bridge and tuning pegs are attached to the wood to hold the strings, and electromagnetic transducers (“pickups”) are placed beneath the strings to pick up their vibrations and send an associated electrical signal out to an amplifier. These basic approaches to guitar design have all gone through significant stages of development, motivated by some of the earlier conceptual flaws found in older or traditional instruments.

Neck-to-body joints that involve “bolt-on” or “set” necks are often weak and decrease the sustain and overall resonance of the instrument. Therefore, attempts were made to create stronger neck-to-body joints via alternative designs. A popular strategy was to have the wood from the neck extend beyond the fretboard all the way through the length of the eventual instrument, thus forming its center. Body “wings” were then glued onto either side (this approach is known as “through the body” construction). Similarly, an alternative method, the “set through neck” construction involved an extended neck tenon (an extension of the same piece of wood that forms the neck) fitted into a groove carved into the body itself and then glued in place with the body wood surrounding it. From the headstock to the end of the body is one piece of wood. There is little if any loss of sustain as there is no joint to the body.

An additional conventional construction, the “set through neck” construction (shown in FIG. 1C), is similar to the “set through neck” construction. Instead of the neck tenon extending through a long channel carved into the guitar body, with the “set through neck” construction the body is essentially absent, and is replaced with a long neck tenon having wings glued on either side.

In both cases, all of the instrument's hardware (tuning pegs, pickups, bridge, tailpiece) are mounted on top of the neck tenon, thereby creating uniform sustain and resonance within the neck. However, both approaches alter the instrument's tone. Since traditional designs do not involve a neck tenon that extends through the body, traditional instruments resonate differently than the above designs. Instead, traditional instruments have their hardware mounted to the body, independent of the wood from the neck, thereby creating a different sort of tone that resonates with the body wood. This difference in tone is most apparent with the pickup closest to the bridge of the instrument, where string vibration is more delicate.

The extended neck tenon designs do offer increased sustain and uniform neck resonance due to the increase of neck mass, but the opportunities to capture many of the classic, “vintage” tones are limited with this design. While these newer designs offer more modem sounds, a different design approach is needed in order to obtain vintage tones in terms of the neck-to-body joint, the electronics, and the overall shape of the instrument. It is to this end that the present invention is directed.

### SUMMARY OF THE INVENTION

In an aspect of the invention, a music instrument capable of emulating particular tones comprises an instrument body, a neck portion having a neck tenon that extends a predetermined distance into the instrument body to form a neck-to-body joint, a neck position pickup mounted above the neck tenon such that the sound captured by the neck position pickup resonates in concert with the neck portion, and a bridge position pickup mounted upon the instrument body such that the sound captured by the bridge position pickup resonates in concert with the instrument body. The neck position pickup and the bridge position pickup emulate respective vintage tones.

Preferably, the instrument body is formed of wood, and the neck-to-body joint enables the music instrument to generate an increased sustain. Also, in a preferred embodiment, the neck portion may extend approximately six inches within the instrument body.

The instrument body may be shaped so as to form an upper horn uniform with the instrument body for causing an increase in the resonance of the instrument body. The shape of the upper horn preferably surrounds a predetermined surface area of the instrument body thereby resulting in a strong neck-to-body joint.

The neck position pickup is preferably a single coil pickup, whereas the bridge position pickup is preferably a Humbucker pickup. A potentiometer is coupled with the neck position pickup and the bridge position pickup for accentuating a high-end frequency range of the bridge position pickup. Preferably, the potentiometer is a 500K potentiometer. The neck position pickup is preferably encased in a metallic cover, such as brass, to filter a high-end frequency range of the neck position pickup. The potentiometer may comprise a first potentiometer for volume control and a second potentiometer for tone control, connected in series.

The music instrument may also comprise a switch for selecting the desired pickup to generate tone. Both pickups may be selected such that the tones generated by respective pickups are combined.

### BRIEF DESCRIPTION OF THE DRAWINGS

FIG. 1A is a diagram illustrating a conventional “bolt on” neck construction;

FIG. 1B is a diagram illustrating a conventional glued-in neck construction;

FIG. 1C is a diagram illustrating a conventional “neck through body” construction;

FIGS. 2A and 2B are respective diagrams illustrating an embodiment of the invention showing a preferred neck tenon construction;

FIG. 3A is a diagram illustrating, in more detail, the neck joint shown in FIG. 2A;

FIG. 3B is a diagram illustrating a side view of the neck joint shown in FIG. 3A;

FIG. 3C is a diagram illustrating a rear view of the neck joint shown in FIG. 3A; and

FIG. 4 is a diagram illustrating an embodiment of the electronics used with the invention.

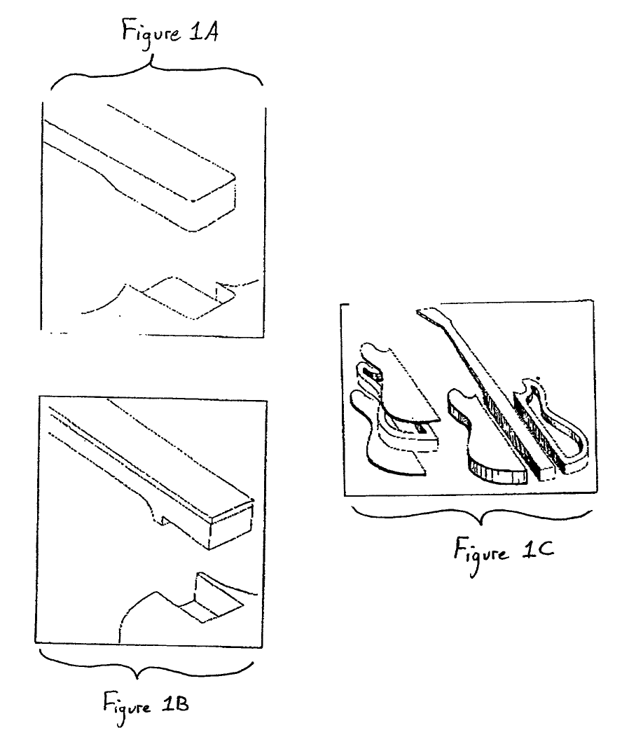

### DETAILED DESCRIPTION OF THE PREFERRED EMBODIMENT

In accordance with an improved guitar of the present invention, the following are some advantages that can be gleaned from using the invention. The design of the guitar preferably maximizes the sustain characteristics of the guitar, improves the balance and playability of the guitar, and faithfully emulates particular vintage tones, such as a Fender Stratocaster (“Strat”) in the “neck” pickup portion, and a Gibson Les Paul (“Les Paul”) in the “bridge” pickup portion of the guitar. Other tones may be emulated without departing from the invention.

It should be noted that these proposed vintage tones have generally been unattainable on a single instrument. Generally, the electronics/body wood combination of one excludes the successful incorporation of the other. Among other aspects, the invention enables vintage tones to be emulated without compromising their sound quality. The following discussion of the structure of the guitar is illustrative.

Body and Neck Construction

There are particular features to the invention that vary from established methods for improving sustain, balance/playability, and tone. Specifically, the neck-to-body joint, and the shape of the body itself, which is based not strictly on aesthetic appearance, but also functions to accomplish the advantages discussed above, contribute to the uniqueness of the invention.

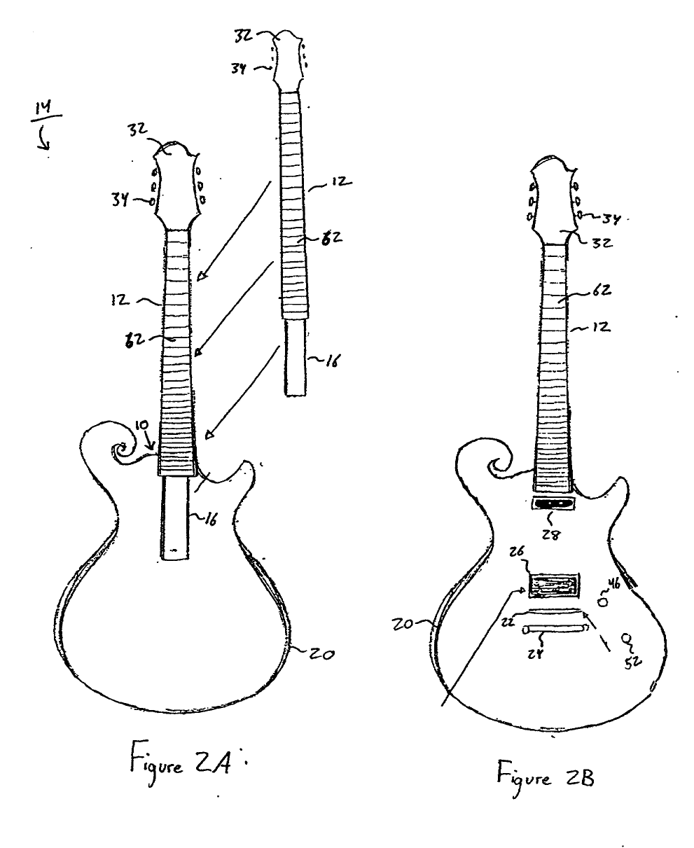

Reference is made to FIGS. 2A and 2B which illustrate, respectively, an embodiment of the invention. With respect to the neck-to-body joint 10, recognizing the benefits of conventional extended neck tenon designs, the present invention improves over this conventional design by causing the wood from the neck 12 to extend substantially throughout the length of the guitar 14. However, contrary to conventional designs, where the neck 12 extends throughout the entire length of the body (the “through the body” construction), or throughout the area where the hardware is to be mounted (the “set through neck” construction), the neck tenon 16 extends a predetermined distance into a groove 18 that is cut into the body portion 20. In one embodiment, the neck tenon 16 extends about six inches into the groove 18. Other variations are possible without departing from the invention. This aspect preferably leaves the bridge 22, tailpiece 24 and the bridge position pickup 26 to be mounted upon the body wood 20, not over the neck tenon 16. The sound captured by the bridge position pickup 26 is therefore not uniform with the vibrations of the neck wood. Rather, like the traditional instruments, it resonates in concert with the body wood 20. This allows the bridge pickup 26 to more faithfully emulate a vintage tone, since it operates in much the same way as traditional guitars, all the while benefiting from the added sustain of the extended neck tenon 16.

This design feature also allows the neck position pickup 28 to function better in reproducing its desired tone, which typically comes from a different wood combination with different tonal qualities in traditional instruments. Since the neck pickup 28 in traditional instruments is not mounted onto the neck tenon 16, but resonates with the body wood, specific types of body woods are generally needed for specific types of pickups in order for the neck position pickup 28 not to be drowned out or muted by the resonance of the body wood.

The neck-to-body joint 10 also allows the neck pickup 28 to be mounted directly above the neck tenon 16, thus allowing for uniform resonance with the neck 12. As such, the body wood 20 of the guitar does not absorb the timbre of the neck position pickup 28. This, aspect coupled with the electronic aspects discussed in more detail below, allows for a more faithful reproduction of the pickup's intended sound than was previously available using conventional guitar designs. Additionally, the neck-to-body joint design allows for increased sustain without adversely affecting the instrument's ability to reproduce vintage tones.

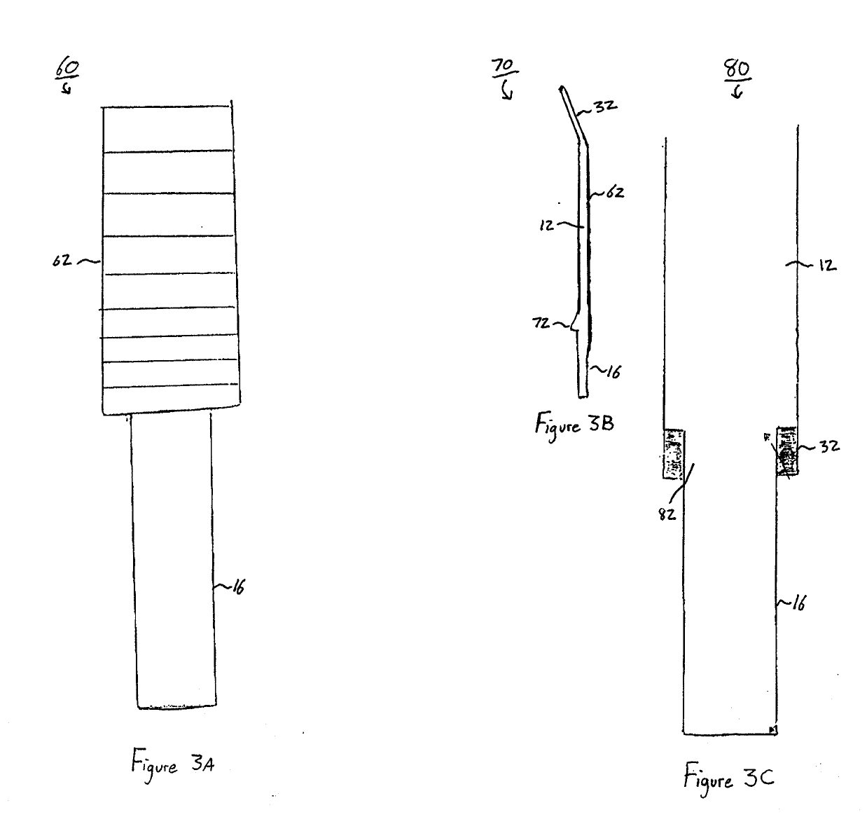

FIGS. 3A-3C illustrate respective views of the neck-to-body joint 10 shown in FIG. 2. In FIG. 3A, a detailed front view 60 of the neck-to-body joint 10 is shown. The neck tenon 16 is constructed of the same piece of wood as the neck 12 under the fretboard 62. In an embodiment of the invention, the neck tenon 16-preferably extends roughly six inches in the body of the guitar.

In FIG. 3B, a detailed side view 70 of the neck-to-body joint 10 is shown. As indicated, a heel portion 72 opposes the fretboard 62 on the neck 12. The heel portion 72 preferably abuts the body of the guitar when the neck tenon 16 is extended into the guitar body to prevent the neck 12 from further extending into the body of the guitar. The heel portion 72 may be formed by appropriately carving a predetermined amount of wood from the neck tenon 16 such that the thickness of the neck tenon 16 is less than that of the heel portion 72. The headstock 32 is formed on the outer edge 74 of the neck 12.

In FIG. 3C, a detailed rear view 80 of the neck-to-body joint 10 is shown. As shown in FIG. 3C, the neck tenon 16 is constructed of the same piece of wood as the neck 12 under the fretboard 62. Preferably, a portion of the fretboard 32 extends over the upper edge 82 of the neck tenon 16.

Body Shape

The preferred shape of the instrument builds upon well known design features that have characterized certain stringed instruments. While a particular body shape is described herein, those skilled in the art will recognize that other body shapes may be used without departing from the invention. In one embodiment of the invention, a prominent feature of the body shape is the upper horn 30 of the instrument, which preferably incorporates a “Florentine Scroll” design that can be found on several conventional mandolins. This feature aids in increasing the resonance of the instrument, as well as providing better balance during playing of the instrument.

Many electric guitars feature extended horns (parts of the body wood that are cut away from the neck so as to improve access to the neck and fretboard), which provide more wood mass to the body and which result in increased resonance. The Florentine Scroll upper horn 30 gives the guitar more body wood mass while allowing it to retain fairly compact dimensions, improving balance. In addition, the manner in which it flows into the rest of the body's shape provides for a stronger neck joint, as it surrounds a greater surface area on the neck tenon 16 when the neck is set in.

The contours of the guitar body are preferably more pronounced and deeper than comparable instruments, and are geared to offset the mass of the Florentine Scroll upper horn 30. This improves balance. The loss this causes to body mass, however, is compensated by the increased thickness of the instrument from front to back. Balance is also improved by the headstock 32 of the guitar 14 (the top part of the neck 12 where the tuning pegs 34 are set into place), which is slightly larger than comparable instruments. In essence, while certain elements of the body design are for aesthetic merit, the instrument's shape is largely geared for optimum resonance and playability.

Electronics

The combination of body and neck woods are designed to complement the unique electronics system of the guitar. The system is preferably based on preexisting pickup features which conventionally have not been combinable for the purposes of faithfully emulating distinct vintage tones. The uniqueness of this system is rooted in the differences between two pickup types: single coils, and humbuckers.

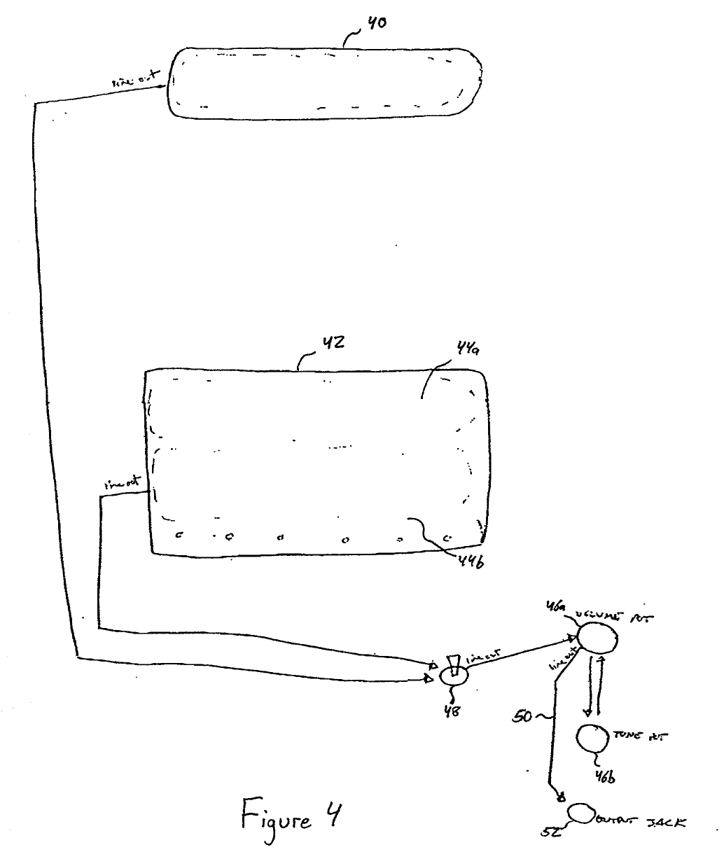

FIG. 4 is a diagram illustrating an embodiment of the electronics used with the invention. Single coil pickups 40, mostly found on Strat-style guitars, are essentially a row of six magnetic poles (not shown), each placed under a string on the instrument, which isolate the sound of the strings at a specific point. They are typically very bright and clear in tone, and are best used through volume and tone controls known as 250K potentiometers, which do not overaccentuate their brightness.

Humbucker pickups 42 are basically two single coils 44a, 44b wired together in opposite polarity, which yield a darker, thicker sort of tone. They are best used with 500K potentiometers to accentuate the high-end frequencies, compensating for their darker tone, and are typically found on Les Paul type guitars. Because of the way they are wired, Humbuckers 42 eliminate unwanted electromagnetic noise and hum.

As mentioned above, the guitar of the invention preferably emulates the sound of a Strat single coil pickup 40 in the neck position 28, and a Les Paul Humbucker 42 in the bridge position 26. Those skilled in the art will recognize that the invention is equally capable of emulating other vintage tones. To do so, the guitar preferably incorporates a single coil pickup 40 by the neck 12, and a Humbucker pickup 42 by the bridge 22. However, this architecture can be problematic in that the two pickups 40, 42 generally require different potentiometers (250K for the single coil pickup 40 and 500K for the Humbucker 42). Using a 250K potentiometer with a Humbucker 42 results in a very muddy tone, since the high-end frequencies are not accentuated. Using a 500K potentiometer with a single coil pickup 40 most often results in far too bright and brittle a sound in a single coil pickup 40.

Accordingly, to serve the Humbucker pickup 42, the guitar of the invention preferably uses a 500K potentiometer 46 (although others could be used), but to ensure that the single coil pickup 40 is not too brittle or bright, the single coil pickup 40 is preferably encased in a brass (or other type) cover (not shown), which cuts out some of its high end frequency. This, in combination with the neck/body woods (which are typically too warm and soft in tone for a single coil pickup), offsets the high-end actuation of the 500K potentiometer 46, thereby resulting in a properly calibrated single coil pickup tone.

Preferably, the two pickups 40, 42 are wired to a standard three-position switch 48. Selecting position 1 may cause the single coil neck pickup 40 to generate tone. Selecting position 2 may cause the Humbucker bridge pickup 42 to generate tone. Selecting position 3 may cause both pickups 40, 42 to generate tone, thus combining the tones from the pickups 40, 42. The 500K potentiometer 46 may be embodied as a 500K potentiometer 46a for volume control, and a 500K potentiometer 46b for tone control. These potentiometers 46a, 46b may be wired together in series, and an electrical line 50 may be connected to an output jack 52 to permit the guitar 14 to be connected with an amplifier (not shown).

Accordingly, many conventional instruments are designed to yield a wide variety of tones. The invention is designed to emulate particular highly useful vintage tones with absolute fidelity. Of particular advantage with the present invention is that no longer are separate vintage guitars needed to faithfully produce such sounds. Thus, the instrument of the invention proves to be extremely versatile. Considering its improvements with sustain, playability, and the combination of otherwise mutually-exclusive sounds, its uniqueness offers distinct advantages over the prior art.

While the foregoing has been described with reference to particular embodiments of the invention, such as a music instrument for generating vintage tones, it will be appreciated by those skilled in the art that changes in these embodiments may be made without departing from the principles and spirit of the invention.

What is claimed is:

1. A music instrument capable of emulating particular tones, comprising:
an instrument body;
a neck portion having a neck tenon that extends a predetermined distance into the instrument body to form a neck-to-body joint;
a neck position pickup mounted above the neck tenon such that the sound captured by the neck position pickup resonates in concert with the neck portion; and
a bridge position pickup mounted upon the instrument body such that the sound captured by the bridge position pickup resonates in concert with the instrument body, such that the neck position pickup and the bridge position pickup emulate respective vintage tones.

2. The music instrument of claim 1, wherein the instrument body is formed of wood.

3. The music instrument of claim 1, wherein the neck-to-body joint enables the music instrument to generate an increased sustain.

4. The music instrument of claim 1, wherein the neck portion extends approximately six inches within the instrument body.

5. The music instrument of claim 1, wherein the instrument body is shaped so as to form an upper horn uniform with the instrument body for causing an increase in the resonance of the instrument body.

6. The music instrument of claim 5, wherein the shape of the upper horn surrounds a predetermined surface area of the instrument body thereby resulting in a strong neck-to-body joint.

7. The music instrument of claim 1, wherein the neck position pickup is a single coil pickup.

8. The music instrument of claim 1, wherein the bridge position pickup is a Humbucker pickup.

9. The music instrument of claim 1, further comprising a potentiometer coupled with the neck position pickup and the bridge position pickup for accentuating a high-end frequency range of the bridge position pickup.

10. The music instrument of claim 9, wherein the potentiometer is a 500K potentiometer.

11. The music instrument of claim 9, wherein the neck position pickup is encased in a metallic cover to filter a high-end frequency range of the neck position pickup.

12. The music instrument of claim 11, wherein the metallic cover is brass.

13. The music instrument of claim 9, wherein the potentiometer comprises a first potentiometer for volume control and a second potentiometer for tone control.

14. The music instrument of claim 13, wherein the first and second potentiometers are connected in series.

15. The music instrument of claim 1, further comprising a switch for selecting the desired pickup to generate tone.

16. The music instrument of claim 15, wherein both pickups are selected such that the tones generated by respective pickups are combined.

17. A music instrument capable of emulating particular tones, comprising:
an instrument body;
a neck portion having a neck tenon that extends a predetermined distance into the instrument body to form a neck-to-body joint;
first means for resonating sound in concert with the neck potion; and
second means for resonating sound in concert with the instrument body, such that the first and second means for resonating sound emulate respective vintage tones.

18. The music instrument of claim 17, wherein the instrument body is formed of wood.

19. The music instrument of claim 17, wherein the neck-to-body joint enables the music instrument to generate an increased sustain.

20. The music instrument of claim 17, wherein the neck portion extends approximately six inches within the instrument body.

21. The music instrument of claim 17, wherein the instrument body is shaped so as to form an upper horn uniform with the instrument body for causing an increase in the resonance of the instrument body.

22. The music instrument of claim 21, wherein the shape of the upper horn surrounds a predetermined surface area of the instrument body thereby resulting in a strong neck-to-body joint.

23. The music instrument of claim 17, further comprising an accentuating means for accentuating a high-end frequency range of the first means for the first means for resonating sound.

24. The music instrument of claim 17, wherein a filtering means filters a high end frequency range of the second means for resonating sound.

25. The music instrument of claim 17, further comprising a switching means for selecting the desired tone.
